(19) United States
(12) Patent Application Publication
(10) Pub. No.: US 2006/0176822 A1
(43) Pub. Date: Aug. 10, 2006

(54) Method, system, service, and computer program product for identifying incorrect domain name to internet protocol (IP) address mappings

(75) Inventors: Ronald P. Doyle, Raleigh, NC (US); John R. Hind, Raleigh, NC (US); Durga D. Mannaru, Raleigh, NC (US); Vivekanand Vellanki, Raleigh, NC (US)

Correspondence Address: HOFFMAN, WARNICK & D'ALESSANDRO LLC, 75 STATE ST, 14TH FLOOR, ALBANY, NY, 12207, US

(73) Assignee: International Business Machines Corporation, Armonk, NY (US)

(21) Appl. No.: 11/053,771

(22) Filed: Feb. 9, 2005

(51) Int. Cl. H04L 12/56; H04L 12/26; H04J 1/16; H04L 12/28

(52) U.S. Cl. 370/241; 370/392

(57) ABSTRACT

The present invention provides a method, system, service, and computer program product for identifying incorrect domain name to IP address mappings. The method comprises: providing a domain name and a valid IP address for the domain name to a plurality of nodes; and at each node: performing a local domain name system (DNS) lookup for the domain name; determining if an IP address returned by the local DNS lookup comprises the valid IP address for the domain name; and providing a notification that an invalid IP address was returned for the domain name if the IP address returned by the local DNS lookup does not comprise the valid IP address for the domain name.

### BACKGROUND OF THE INVENTION

1. Field of the Invention

The present invention generally relates to domain names. More particularly, the present invention provides a method, system, service, and computer program product for identifying incorrect domain name to IP address mappings.

2. Related Art

An IP address is an address used to uniquely identify a device on an IP network, such as the Internet. An IP address is made up of 32 binary bits which can be divisible into a network portion and host portion with the help of a subnet mask. The 32 binary bits are broken into four octets (1 octet=8 bits). Each octet is converted to decimal and separated by a period (dot). For this reason, an IP address is said to be expressed in dotted decimal format (e.g., 129.42.19.99).

Because IP addresses are difficult for humans to remember, the domain name system (DNS) was created. As known in the art, DNS is a system that maps a domain name (e.g., www.ibm.com) to a corresponding IP address (e.g., 129.42.19.99). DNS allows a user to specify an IP address using an easily remembered domain name, rather than a sequence of hard to remember numbers. Unfortunately, although DNS greatly simplifies the task of navigating to specific IP addresses on the Internet, it is not infallible. For example, under certain conditions, a domain name may be mapped to an invalid IP address. This could happen for several reasons, including, for example, an incorrect DNS entry, DNS spoofing, a compromised DNS, a compromised router, a compromised computer (e.g., a compromised personal computer (PC)), etc. Several of these situations are illustrated in FIG. 1.

In section (A) of FIG. 1, a web user 10 enters the domain name www.ibm.com and is provided with an invalid IP address by a compromised DNS server 12, in which the entry corresponding to www.ibm.com has been modified. This could occur, for example, if a hacker accessed the DNS server 12 and modified the entry corresponding to www.ibm.com. In section (B) of FIG. 1, a router 14 for directing a domain name lookup to a particular DNS server has been compromised (e.g., by a hacker). That is, instead of directing the domain name lookup to the correct DNS server 16 as indicated by the dashed arrow 18 in section (B) of FIG. 1, the compromised router 14 directs the domain name lookup to a “bad” DNS server 16′ as indicated by the solid arrow 20, which is configured to return an invalid IP address for the domain name lookup. Finally, in section (C) of FIG. 1, the web user's PC itself has been compromised (e.g., by a virus) to point to an incorrect DNS server. That is, instead of directing the domain name lookup to the correct DNS server 16 as indicated by the dashed arrow 22 in section (C) of FIG. 1, the web user's 10 compromised PC directs the domain name lookup to a “bad” DNS server 16′ as indicated by the solid arrow 24, which is configured to return an invalid IP address for the domain name lookup.

Although the web site at an invalid IP address could be completely benign, there is the chance that the web site has been set up to simulate a known web site in order to fool a web user into inputting confidential/personal information. Once this confidential/personal information has been obtained, it can be used for illicit purposes, such as identity theft, unauthorized purchases, etc.

Currently, the owner, provider, host, administrator, etc., of a web site (e.g., a business) has no way of detecting when a domain name corresponding to the web site has been mapped to an invalid IP address. Such detection would allow an entity responsible for the web site/domain name to investigate the cause of the incorrect IP address mapping and take any steps necessary to remedy the incorrect mapping. Accordingly, there exists a need for a method, system, service, and computer program product for identifying incorrect domain name to IP address mappings.

### SUMMARY OF THE INVENTION

In general, the present invention provides a method, system, service, and computer program product for identifying incorrect domain name to IP address mappings. In particular, a large number of locations (nodes) on the Internet are used to perform a local DNS lookup for a domain name. At each node, the resulting IP address is then compared to one or more valid IP addresses for the domain name. When an IP address returned in a local DNS lookup does not match one of the valid IP addresses for the domain name, the node notifies a validation controller. The validation controller notifies the entity responsible for the domain name of the error and provides additional information that will allow the entity to investigate the problem further. Each node can perform a local DNS lookup for a plurality of different domain names corresponding to one or more entities.

A first aspect of the present invention is directed to a method for identifying incorrect domain name to Internet Protocol (IP) address mappings, comprising: providing a domain name and a valid IP address for the domain name to a plurality of nodes; and at each node: performing a local domain name system (DNS) lookup for the domain name; determining if an IP address returned by the local DNS lookup comprises the valid IP address for the domain name; and providing a notification that an invalid IP address was returned for the domain name if the IP address returned by the local DNS lookup does not comprise the valid IP address for the domain name.

A second aspect of the present invention is directed to a system for identifying incorrect domain name to Internet Protocol (IP) address mappings, comprising: a system for providing a domain name and a valid IP address for the domain name to a plurality of nodes; and wherein each node comprises: a system for performing a local domain name system (DNS) lookup for the domain name; a system for determining if an IP address returned by the local DNS lookup comprises the valid IP address for the domain name; and a system for providing a notification that an invalid IP address was returned for the domain name.

A third aspect of the present invention is directed to a program product stored on a recordable medium for identifying incorrect domain name to Internet Protocol (IP) address mappings, which when executed comprises: program code for providing a domain name and a valid IP address for the domain name to a plurality of nodes; and at each node: program code for performing a local domain name system (DNS) lookup for the domain name; program code for determining if an IP address returned by the local DNS lookup comprises the valid IP address for the domain name; and program code for providing a notification that an invalid IP address was returned for the domain name if the IP address returned by the local DNS lookup does not comprise the valid IP address for the domain name.

A fourth aspect of the present invention is directed to a method for identifying incorrect domain name to Internet Protocol (IP) address mappings, comprising: at each of a plurality of nodes connected to a network: receiving a domain name and a valid IP address for the domain name; performing a local domain name system (DNS) lookup for the domain name; determining if an IP address returned by the local DNS lookup comprises the valid IP address for the domain name; and providing a notification that an invalid IP address was returned for the domain name if the IP address returned by the local DNS lookup does not comprise the valid IP address for the domain name.

A fifth aspect of the present invention is directed to a method for deploying an application for identifying incorrect domain name to Internet Protocol (IP) address mappings, comprising: providing a computer infrastructure being operable to: receive a domain name and a valid IP address for the domain name from an entity; perform a local domain name system (DNS) lookup for the domain name at a plurality of nodes connected to a network; compare an IP address returned by the DNS lookup to the valid IP address; and notify the entity that an invalid IP address was returned for the domain name if the IP address returned for the domain name does not match the valid IP address.

A sixth aspect of the present invention is directed to computer software embodied in a propagated signal for identifying incorrect domain name to Internet Protocol (IP) address mappings, the computer software comprising instructions to cause a computer system to perform the following functions: provide a domain name and a valid IP address for the domain name to a plurality of nodes; and at each node: perform a local domain name system (DNS) lookup for the domain name; determine if an IP address returned by the local DNS lookup comprises the valid IP address for the domain name; and provide a notification that an invalid IP address was returned for the domain name if the IP address returned by the local DNS lookup does not comprise the valid IP address for the domain name.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts several causes for incorrect domain name to IP address mappings.

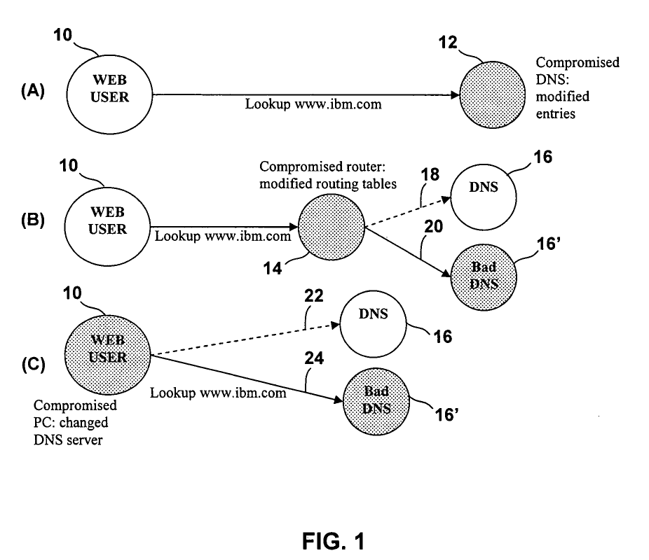

FIG. 2 depicts a validation system for identifying incorrect domain name to IP address mappings in accordance with an embodiment of the present invention.

FIG. 3 depicts a flow diagram illustrating a method performed by each node of the validation system of FIG. 2 in accordance with an embodiment of the present invention.

FIG. 4 depicts a computer system for implementing the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As indicated above, the present invention provides a method, system, service, and computer program product for identifying incorrect domain name to IP address mappings. In particular, a large number of locations (nodes) on the Internet are used to perform a local DNS lookup for a domain name. At each node, the resulting IP address is then compared to one or more valid IP addresses for the domain name. When an IP address returned in a local DNS lookup does not match one of the valid IP addresses for the domain name, the node notifies a validation controller. The validation controller notifies the entity responsible for the domain name of the error and provides additional information that will allow the responsible entity to investigate the problem further. Each node can perform a local DNS lookup for a plurality of different domain names corresponding to one or more entities.

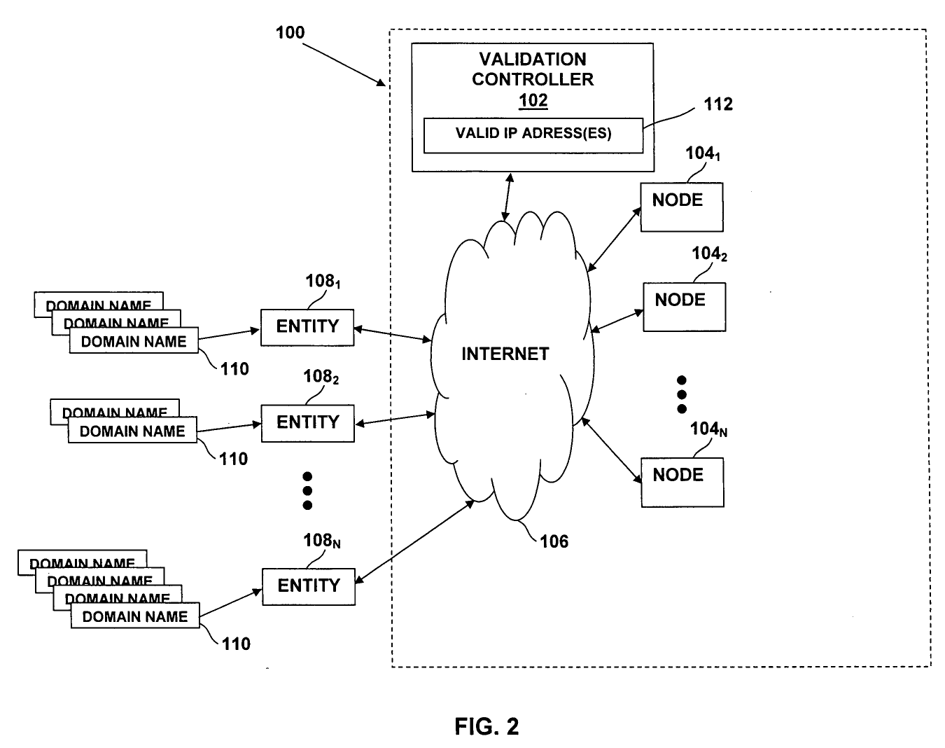

A illustrative validation system 100 for identifying incorrect domain name to IP address mappings in accordance with an embodiment of the present invention is depicted in FIG. 2. The validation system 100 generally includes a validation controller 102 and a plurality of client computers 104 (104₁, 104₂, . . . , 104_{N}), hereafter referred to as “nodes.” The validation system 100 is connected to the plurality of nodes 104 via the Internet 106 or other suitable network. The plurality of nodes 104 are connected to the Internet 106 to allow the nodes 104 to perform local DNS lookups. At least one entity 108 (108₁, 108₂, . . . , 108_{N}), each having at least one domain name 110 to be processed by validation system 100, communicates with the validation controller 102. Communication can be via the Internet 106 as shown or in any other suitable now known or later developed manner.

Any suitable number of nodes 104 can be used in the practice of the present invention. For example, 1,000 to 10,000 nodes 104 could be used. As will be apparent to one skilled in the art, a larger number of nodes 104, spread out over a larger area, will increase the chances of identifying incorrect domain name to IP address mappings.

This present invention provides a validation system 100 by which an entity 108 (e.g., a business) can identify if and when one or more of its domain names 110 is mapped to an incorrect IP address. To this extent, each entity 108 that desires to identify incorrect domain name to IP address mappings connects to the validation system 100. The validation system 100 can be provided, for example, as a free or fee-based service (e.g., a web service) accessible to an entity 108 via the Internet 106, or in any other suitable manner.

Once connected to the validation system 100, each entity 108 provides the validation controller 102 with at least one domain name 110 and a list 112 of one or more valid IP addresses to which each domain name 110 should be mapped, or provides other information that will allow the validation controller 102 to gather the valid IP address(es) itself. This information may comprise, for example, a list of valid IP addresses to an authoritative DNS server (this list can be obtained by a TCP query). Other techniques for obtaining valid IP addresses for each domain name 110 are also possible.

The validation system 100 operates by performing a plurality local DNS lookups using a plurality of nodes 104 on the Internet 106. A list 112 containing one or more valid IP addresses for each domain name 110 to be validated is provided by the validation controller 102 to each of the plurality of nodes 104.

For each domain name 110 assigned to a node 104, the node 104 performs a local DNS lookup for the domain name 110. The resulting IP address is then compared with the list 112 of one or more valid IP addresses for the domain name 110. When an IP address returned in a local DNS lookup does not match one of the valid IP addresses on the list 112 for the domain name 110, the node 104 notifies the validation controller 102 of the error and provides the validation controller 102 with information regarding the error. The information regarding the error can be used by the entity 108 to which the domain name 110 belongs to remedy the situation.

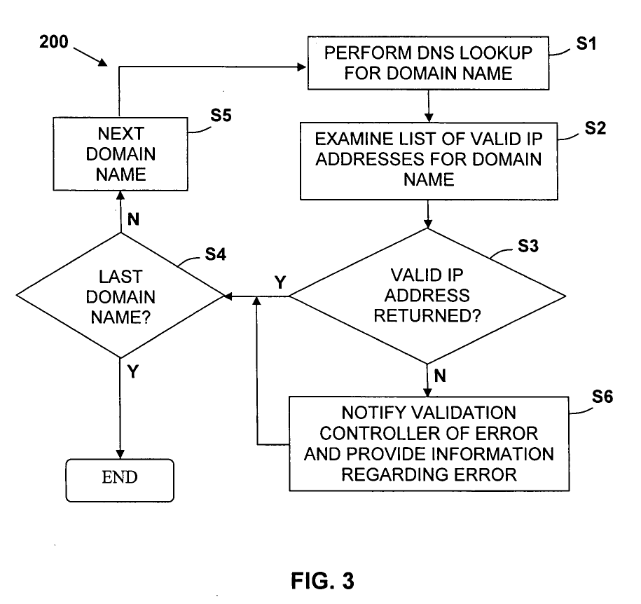

Each node 104 of the validation system 100 performs the method 200 illustrated in FIG. 3. In step S1, a node 104 performs a local DNS lookup for a domain name 110 assigned to the node 104. In step S2, the node 104 examines the list 112 of one or more valid IP addresses for the domain name 110. In step S3, if the IP address returned by the DNS lookup is found on the list 112 (i.e., a valid IP address has been returned for the domain name 110), then flow passes to step S4. In step S4, if another domain name 110 has been assigned to the node 104, then the domain name 110 is determined (step S5) and a local DNS lookup is performed in step S1 for the domain name 110. If, in step S4, the domain name 110 is the last domain name 110 assigned to the node 104, then flow ends.

In step S3, if the IP address returned by the DNS lookup is not found on the list 112 of one or more valid IP addresses for the domain name 110 (i.e., an invalid IP address has been returned for the domain name 110), then in step S6 the node 104 notifies the validation controller 102 of this error and provides the validation controller 102 with information regarding the error. Flow then passes back to step S4. Method 200 can be periodically repeated for each node 104 according to a predetermined schedule, which can be provided by the validation controller 102 or in any other suitable manner. For example, method 200 can be repeated by each node 104 once a day, once a week, once a month, etc. Other schedules, both periodic or non-periodic, are also possible.

The validation controller 102 reports the error to the corresponding entity 108 responsible for the domain name 110, and provides additional information to the entity 108 to allow the entity 108 to further investigate the problem. Such information may include, for example, the domain name 110 for which an invalid IP address was returned, the invalid IP address that the local DNS lookup returned, information regarding the DNS server that returned the invalid IP address, information regarding the node 104 that requested the local DNS lookup, etc. Further, the validation controller 102 can use this information to identify/notify compromised DNS servers, compromised routers, and/or compromised PCs of the problem.

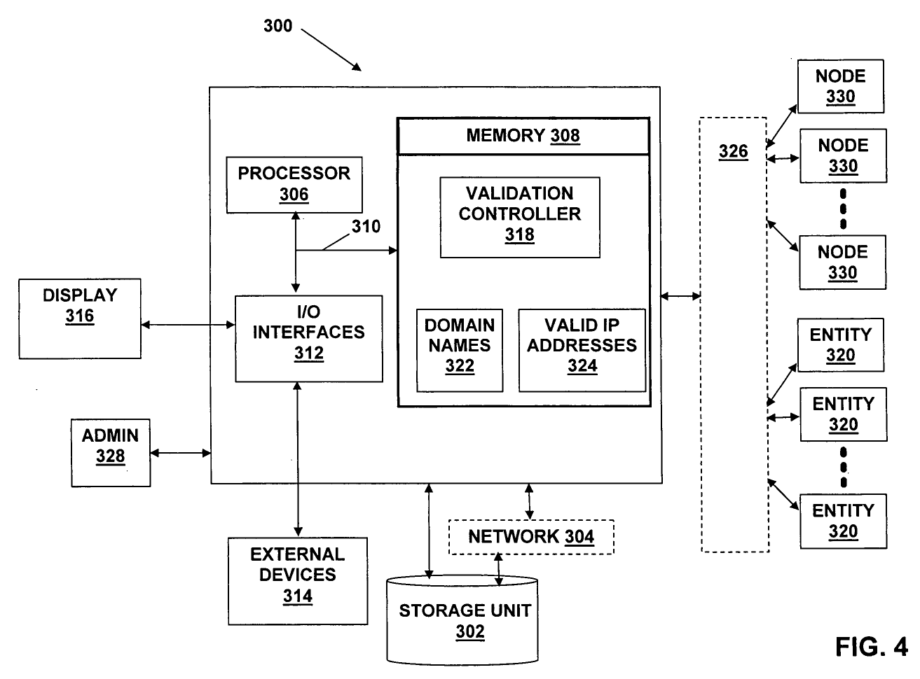

Referring now to FIG. 4, there is illustrated a computer system 300 for identifying incorrect domain name to IP address mappings in accordance with the present invention. Computer system 300 is intended to represent any type of computerized system capable of implementing the methods of the present invention. For example, computer system 300 may comprise a desktop computer, laptop computer, workstation, server, client, hand-held device, pager, etc.

Each domain name 110 and its corresponding list 112 of one or more valid IP addresses can be stored locally to computer system 300, for example, in storage unit 302, and/or may be provided to computer system 300 over a network 304. Storage unit 302 can be any system capable of providing storage for data and information under the present invention. As such, storage unit 302 may reside at a single physical location, comprising one or more types of data storage, or may be distributed across a plurality of physical systems in various forms. In another embodiment, storage unit 302 may be distributed across, for example, a local area network (LAN), wide area network (WAN) or a storage area network (SAN) (not shown). Network 304 is intended to represent any type of network over which data can be transmitted. For example, network 304 can include the Internet, a wide area network (WAN), a local area network (LAN), a virtual private network (VPN), a WiFi network, or other type of network. To this extent, communication can occur via a direct hardwired connection or via an addressable connection in a client-server (or server-server) environment that may utilize any combination of wireline and/or wireless transmission methods. In the case of the latter, the server and client may utilize conventional network connectivity, such as Token Ring, Ethernet, WiFi or other conventional communications standards. Where the client communicates with the server via the Internet, connectivity could be provided by conventional TCP/IP sockets-based protocol. In this instance, the client would utilize an Internet service provider to establish connectivity to the server.

As shown, computer system 300 generally includes a processor 306, memory 308, bus 310, input/output (I/O) interfaces 312 and external devices/resources 314. Processor 306 may comprise a single processing unit, or may be distributed across one or more processing units in one or more locations, e.g., on a client and server. Memory 308 may comprise any known type of data storage and/or transmission media, including magnetic media, optical media, random access memory (RAM), read-only memory (ROM), etc. Moreover, similar to processor 306, memory 308 may reside at a single physical location, comprising one or more types of data storage, or be distributed across a plurality of physical systems in various forms.

I/O interfaces 312 may comprise any system for exchanging information to/from an external source. External devices/resources 314 may comprise any known type of external device, including speakers, a CRT, LED screen, handheld device, keyboard, mouse, voice recognition system, speech output system, printer, monitor/display (e.g., display 316), facsimile, pager, etc.

Bus 310 provides a communication link between each of the components in computer system 300, and likewise may comprise any known type of transmission link, including electrical, optical, wireless, etc. In addition, although not shown, other components, such as cache memory, communication systems, system software, etc., may be incorporated into computer system 300.

Shown in memory 308 is a validation controller 318, which may be provided as a computer program product. The validation controller 318 is configured to receive, from one or more entities 320, at least one domain name 322 and a list 324 of one or more valid IP addresses (or way of obtaining valid IP addresses) for each domain name 322. The validation controller 318 can be connected to each entity 320 via the Internet 326 as shown, or using any other suitable network (e.g., network 304). Domain names 322 and lists 324 of valid IP addresses for each domain name 322 can also be provided to computer system 300 by an administrator 328 or the like.

The validation controller 318 communicates with a plurality of nodes 330 over the Internet 326 or using any other suitable network (e.g., network 304), wherein each node typically comprises structure similar to that of computer system 300. The validation controller 318 provides each node 330 with one or more domain names 322 and a list 324 of one or more valid IP addresses for each domain name. Each node 330 performs a local DNS lookup as described above with regard to FIG. 3 for each domain name to identify any incorrect domain name to IP address mappings. Upon identification of an incorrect domain name to IP address mapping by a node 330, the node 330 notifies the validation controller 318 of the error and provides information regarding the error to the validation controller 318, which notifies the entity 320 associated with the domain name that a problem exists.

It should be appreciated that the teachings of the present invention can be offered as a business method on a subscription or fee basis. For example, computer system 300 could be created, maintained, supported, and/or deployed by a service provider that offers the functions described herein for customers. That is, a service provider could be used to identify incorrect domain name to IP address mappings, as describe above. For example, a service provider could employ a business model in which a premium (rebate/discount on products, etc.) of some sort is offered to users of client PCs to host a background application for identifying incorrect domain name to IP address mappings when the client PCs are on-line. The nodes 104 can also be leased, owned, or otherwise controlled by the service provider. This service could also be implemented by companies that have access to machines belonging to a large portion of the Internet, such as consolidated data networks (CDNs), PC harvesting companies, Internet Service Providers (ISPs), etc. Many other business models are also possible.

It should also be understood that the present invention can be realized in hardware, software, a propagated signal, or any combination thereof. Any kind of computer/server system(s)- or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

We claim:

1. A method for identifying incorrect domain name to Internet Protocol (IP) address mappings, comprising:
providing a domain name and a valid IP address for the domain name to a plurality of nodes; and
at each node:
performing a local domain name system (DNS) lookup for the domain name;
determining if an IP address returned by the local DNS lookup comprises the valid IP address for the domain name; and
providing a notification that an invalid IP address was returned for the domain name if the IP address returned by the local DNS lookup does not comprise the valid IP address for the domain name.

2. The method of claim 1, wherein the plurality of nodes are connected to the Internet.

3. The method of claim 1, further comprising:
repeating the method according to a predetermined schedule.

4. The method of claim 1, wherein, in response to the notification that an invalid IP address was returned for the domain name, providing information regarding the invalid IP address to an entity responsible for the domain name.

5. The method of claim 4, wherein the valid IP address or a method for obtaining the valid IP address is provided by the entity responsible for the domain name.

6. A system for identifying incorrect domain name to Internet Protocol (IP) address mappings, comprising:
a system for providing a domain name and a valid IP address for the domain name to a plurality of nodes; and
wherein each node comprises:
a system for performing a local domain name system (DNS) lookup for the domain name;
a system for determining if an IP address returned by the local DNS lookup comprises the valid IP address for the domain name; and
a system for providing a notification that an invalid IP address was returned for the domain name.

7. The system of claim 6, wherein the plurality of nodes are connected to the Internet.

8. The system of claim 6, wherein the system for performing a local domain name system (DNS) lookup for the domain name repeats the DNS lookup for the domain name according to a predetermined schedule.

9. The system of claim 6, further comprising:
a system for providing information regarding the invalid IP address to an entity responsible for the domain name.

10. A program product stored on a recordable medium for identifying incorrect domain name to Internet Protocol (IP) address mappings, which when executed comprises:
program code for providing a domain name and a valid IP address for the domain name to a plurality of nodes; and
at each node:
program code for performing a local domain name system (DNS) lookup for the domain name;
program code for determining if an IP address returned by the local DNS lookup comprises the valid IP address for the domain name; and
program code for providing a notification that an invalid IP address was returned for the domain name if the IP address returned by the local DNS lookup does not comprise the valid IP address for the domain name.

11. The program product of claim 10, wherein the plurality of nodes are connected to the Internet.

12. The program product of claim 10, further comprising:
repeating the method according to a predetermined schedule.

13. The program product of claim 10, wherein, in response to the notification that an invalid IP address was returned for the domain name, providing information regarding the invalid IP address to an entity responsible for the domain name.

14. The program product of claim 4, wherein the valid IP address or a method for obtaining the valid IP address is provided by the entity responsible for the domain name.

15. A method for identifying incorrect domain name to Internet Protocol (IP) address mappings, comprising:
at each of a plurality of nodes connected to a network:
receiving a domain name and a valid IP address for the domain name;
performing a local domain name system (DNS) lookup for the domain name;
determining if an IP address returned by the local DNS lookup comprises the valid IP address for the domain name; and
if the IP address returned by the local DNS lookup does not comprise the valid IP address for the domain name, providing a notification that an invalid IP address was returned for the domain name.

16. The method of claim 15, wherein the network comprises the Internet.

17. The method of claim 15, further comprising:
repeating the method according to a predetermined schedule.

18. The method of claim 15, wherein, in response to the notification that an invalid IP address was returned for the domain name, providing information regarding the invalid IP address to an entity responsible for the domain name.

19. A method for deploying an application for identifying incorrect domain name to Internet Protocol (IP) address mappings, comprising:
providing a computer infrastructure being operable to:
receive a domain name and a valid IP address for the domain name from an entity;
perform a local domain name system (DNS) lookup for the domain name at a plurality of nodes connected to a network;
compare an IP address returned by the DNS lookup to the valid IP address; and
notify the entity that an invalid IP address was returned for the domain name if the IP address returned for the domain name does not match the valid IP address.

20. Computer software embodied in a propagated signal for identifying incorrect domain name to Internet Protocol (IP) address mappings, the computer software comprising instructions to cause a computer system to perform the following functions:
provide a domain name and a valid IP address for the domain name to a plurality of nodes; and
at each node:
perform a local domain name system (DNS) lookup for the domain name;
determine if an IP address returned by the local DNS lookup comprises the valid IP address for the domain name; and
provide a notification that an invalid IP address was returned for the domain name if the IP address returned by the local DNS lookup does not comprise the valid IP address for the domain name.
